(19) United States
(12) Patent Application Publication
(10) Pub. No.: US 2012/0256410 A1
(43) Pub. Date: Oct. 11, 2012

(54) All Inclusive Manway and Sump Connector

(76) Inventor: David D. Russell, Blodgett, MO (US)

(21) Appl. No.: 13/441,655

(22) Filed: Apr. 6, 2012

Related U.S. Application Data
(60) Provisional application No. 61/472,405, filed on Apr. 6, 2011.

(51) Int. Cl. F16L 23/00; F16L 55/10; B23P 11/00

(52) U.S. Cl. 285/119; 29/428

(57) ABSTRACT

An all-inclusive manway and sump connector designed to allow for the attachment of both manway covers and sumps to the manway of an underground storage tank without the need for an adapter or the retrofitting of the manway which was required with the devices and modalities of the prior art.

### CROSS REFERENCE TO RELATED APPLICATION(S)

This Application claims the benefit of U.S. Provisional Patent Application Ser. No. 61/472,405, filed Apr. 6, 2012, the entire disclosure of which is incorporated herein by reference.

### BACKGROUND OF THE INVENTION

1. Field of the Invention

This disclosure is related to the field of connectors and access points for underground storage tanks. Specifically, this disclosure is related to the field of manway covers and sump connectors for use in underground storage tanks.

2. Description of Related Art

An underground tank is a storage facility for a certain substance, the majority of the tank being beneath ground level. Underground storage tanks (USTs) can include farm and residential tanks for the storage of fuel or other substances for noncommercial purposes, tanks used for storing heating oil for consumptive use, tanks for the storage of regulated substances and septic tanks. A UST, as that term is defined by Federal law, is any one or combination of tanks (including the underground pipes connected thereto) that is used to contain an accumulation of regulated substances (such as petroleum), the volume of which (including the volume of the underground pipes connected thereto) is ten (10) percent or more beneath the surface of the ground.

Generally, USTs fall into four different types: 1) steel aluminum tanks; 2) composite overwrapped metal tanks (aluminum/steel) which have filament windings like glass fiber/aramid, carbon fiber or a plastic compound around the metal cylinder for corrosion protection; 3) tanks made from a composite material such as, but not limited to, fiberglass/aramid or carbon fiber with a metal liner (such as aluminum or steel); and 4) tanks made from a composite material with a polymer liner (e.g., a thermoplastic liner).

No matter the type or use, most USTs will usually have to have a point of ingress and egress to the surface from which an individual can access the inside of the UST for maintenance or routine services. Since a UST is generally located underground (i.e., generally inaccessible for routine “walk up to it and check” maintenance), a surface level access point for the UST is required. Many USTs utilize manways as this access point. Manways are surface openings to an underground interstitial space (such as a UST) used to house an access point for making connections or performing maintenance on the underground area. A manway is usually covered by a manway cover at the terminating end of the manway at the surface, which is generally at or substantially close to ground level.

In addition to providing a point of ingress and egress, manways are also an access point for making connections to the UST. One common connection to UST manways is a sump, which is attached to the inlet and outlet fittings on the UST. Sumps generally function to catch or retain fluid leakage at the fittings to the UST. Sumps are commonly attached to a UST at manway openings. However, problematically for the art, the dimensions of the manway opening generally do not correspond with the dimensions of the sump. Generally, the diameters of the standard UST manway openings are smaller than the diameters of the gasket and compression ring for standard sumps.

This incongruity between the diameters of the sump and the manway opening of USTs has caused problems in the art for the attachment of sumps to the UST via a manway. Stated differently, without additional securing, the sump cannot be securely fastened to the UST manway in a manner that provides for proper functioning. Traditionally, this attachment issue has commonly been solved by either the use of a manway/sump adapter kit or the retrofitting of the manway with an inverted flange manway pipe fitting. However, both of these solutions are complex, involve multiple parts and are expensive in terms of both labor and parts.

### SUMMARY OF THE INVENTION

Because of these and other problems in the art, described herein, among other things, is an all-inclusive manway and sump connector designed to allow for the attachment of both manway covers and sumps to the manway of a UST.

There is described herein, among other things, an all-inclusive manway and sump connector for an underground storage tank with a manway, the connector comprising: a manway throat with a posterior end and an anterior end and a length there between, the anterior end of the manway throat being attached to the manway; a manway flange attached to and extending out laterally away from the posterior end of the manway throat, the manway flange having a top surface; an inner bolt pattern sized and shaped to attach to a manway cover and located on the top surface of the manway flange; an outer bolt pattern sized and shaped to attach to a sump and located on the top surface of the manway flange; wherein the inner bolt pattern and the outer bolt pattern allow for simultaneous attachment of both the manway cover and the sump to the underground storage tank.

In one embodiment of the all-inclusive manway and sump connector, the manway throat will be cylindrical in shape.

In another embodiment of the all-inclusive manway and sump connector, the sump will be attached to the outer bolt pattern by attachment openings on a sump gasket or a sump compression ring. In another embodiment of the all-inclusive manway and sump connector, the sump will be attached to the outer bolt pattern by attachment openings on the sump compression ring and the sump gasket.

In another embodiment of the all-inclusive manway and sump connector, wherein the manway cover will be attached to the inner bolt pattern by attachment openings on the manway cover or on a manway cover gasket. In another embodiment, the sump will be attached to the inner bolt pattern by attachment openings on the manway cover and the manway cover gasket.

Also disclosed herein is a method of simultaneously attaching a manway cover and a sump to a manway opening to an underground storage tank, the method comprising: providing an underground storage tank with a manway opening; providing an all-inclusive manway and sump connector connected to the manway opening, the all-inclusive manway and sump connector comprising: a manway throat with a posterior end and an anterior end and a length there between, the anterior end of the manway throat being attached to the manway; a manway flange attached to and extending out laterally away from the posterior end of the manway throat, the manway flange having a top surface; an inner bolt pattern sized and shaped to attach to a manway cover and located on the top surface of the manway flange; an outer bolt pattern sized and shaped to attach to a sump and located on the top surface of the manway flange; attaching the manway cover to the inner bolt pattern on the manway flange; and attaching the sump to the outer bolt pattern on the manway flange.

### BRIEF DESCRIPTION OF THE DRAWINGS

FIG. 1 provides a prospective view of an embodiment of the all-inclusive manway and sump connector of the present application in conjunction with a manway and underground storage tank.

FIGS. 2a, 2b and 2c provide a perspective, top and side view of the disclosed all inclusive manway and sump connector.

### DESCRIPTION OF THE PREFERRED EMBODIMENT(S)

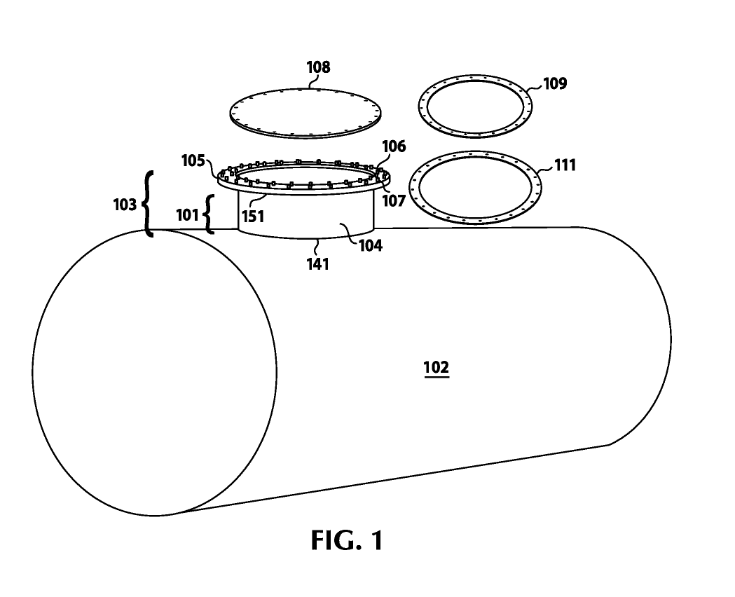

FIG. 1 provides a prospective view of an embodiment of the all-inclusive manway and sump connector (103) of the present application in conjunction with a manway (101) and a UST (102). As seen in FIG. 1, the manway (101) is generally located on the top of the UST (102), connecting the UST (102), which is underground, to the surface. While the orientation provided in FIG. 1 is a common positioning for manways, it should be understood that this orientation is in no way meant to be limiting as this application contemplates any orientation of manways and USTs as known to those of ordinary skill in the art.

The all-inclusive manway and sump connector (103) provided in FIG. 1 is generally comprised of a manway throat (104), a manway flange (105), an inner bolt pattern (106) on the manway flange (105) and an outer bolt pattern (107) on the manway flange (105). Generally, it is contemplated that the all-inclusive manway and sump connector may be comprised of fiberglass, resin and composite fiberglass, steel, metal alloys, thermoplastic materials or any other suitable material known to those of ordinary skill in the art. As depicted in FIG. 1, the manway throat (104) is generally cylindrical in shape with a posterior end (151) and an anterior end (141) and a length there between. In other embodiments, the manway throat will be generally a prism shape as known to those of ordinary skill in the art with a posterior end (151), an anterior end (141) and a length there between. Broadly, any three-dimensional hollow shape with an anterior (141) and a posterior end (151) and a length there between and two open faces with generally similar shapes and dimensions is contemplated in this application. The manway throat (104) is generally attached to the manway (101) at its anterior (141) end by any form or mode of attachment known to those of ordinary skill in the art such as, but not limited to, welding. In other embodiments, the anterior (141) end of the manway throat (104) will be directly attached to the manway opening (101) on the UST (102). Both permanent and temporary modes of attachment known to those of ordinary skill in the art for attaching the manway throat (104) to the manway opening (101) on the UST (102) are contemplated. At the posterior (151) terminating end of the manway throat (104), there is a manway flange (105). The manway flange (105) is generally attached to the posterior end (151) of the manway throat (104) in one embodiment by welding. However, any permanent or temporary mode of attachment known to those of ordinary skill in the art is contemplated. The terminating posterior end (151) of the manway throat (104) is generally located at or above ground level, i.e., at the ground surface or other location where an individual can access it.

The manway flange (105) is generally a lip of a certain width generally flush with and extending out laterally away from the exterior circumference or perimeter of the posterior end (151) of the manway throat (104). Accordingly, the diameter or perimeter of the manway flange (105) is always greater than the diameter or perimeter of the manway throat (104). In certain embodiments, as depicted in FIG. 1, the manway flange (105) will be flush with the posterior (151) terminating end of the manway throat (104). However this arrangement is by no means required. Any orientation in which the manway flange (105) is attached to the posterior (151) terminating portion of the manway throat (104) and is wider in diameter or perimeter than the manway throat (104) is contemplated in this disclosure. Contemplated widths of the lip of the manway flange (105) is any width upon which an inner bolt pattern (106) and an outer bolt pattern (107) can be placed.

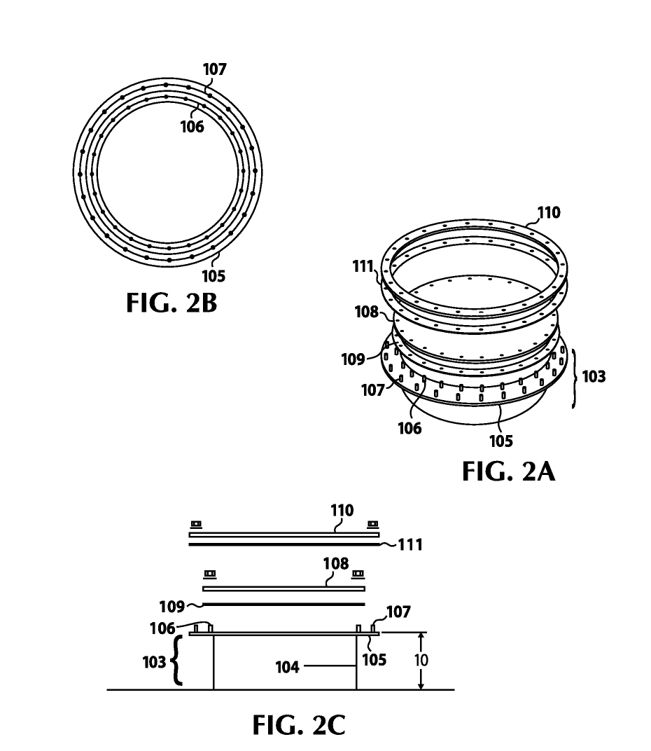

The inner bolt pattern (106) of the all-inclusive manway and sump connector (103) is an inner ring of bolts on the top surface of the lip of the manway flange (105) which generally corresponds to an attachment means on a manway cover (108) and/or a manway cover gasket (109). The term “bolt” as used in this application should be understood to mean any screw, bolt, joint, dowel, peg, pin, rivet, anchor, fastener or other fastening means known to those of ordinary skill in the art. The term “attachment means” as used in this application should be understood to mean any hole, clip, joint, anchor or other attaching or fasting means known to those of ordinary skill in the art that is capable of corresponding to the inner (106) and outer bolt patterns (107). For example, as depicted in FIGS. 2a and 2b, in one embodiment, the inner (106) and outer bolt patterns (107) will comprise raised bolts and the attachment means will comprise corresponding attachment holes the bolts are placed within during attachment. In this embodiment, the sump and the manway cover can be secured via winged cuts or other modality for securing known to those of ordinary skill in the art. The bolts can be any number or size or be placed at any distance relative to each other, so long as they correspond with the attachment openings in the manway cover (108) and/or manway cover gasket (109). In an embodiment, the inner bolt pattern (106) will consist of 24 ½″ bolts. The inner bolt pattern (106) will be located closer to the inner diameter or perimeter of the manway flange (105) than the outer diameter or perimeter of the manway flange (105) (i.e., closer to the hollow interior of the manway flange (105)). The outer bolt pattern (107) is an outer ring of bolts on the lip of the manway flange (105) which generally corresponds to a bolting pattern on a sump compression ring (110) and/or a sump gasket (111). The outer bolt pattern (107) will be larger in diameter or perimeter than the inner bolt pattern (106). Accordingly, the outer bolt pattern (107) will be located closer to the outer diameter of the flange (105) than the inner diameter of the flange (105) (i.e., it will be further from the hollow interior of the manway flange (105) than the inner bolt pattern (106)). The bolts in the outer bolt pattern (107) can be any number or size or placed at any distance relative to each other, so long as they correspond with the attachment openings in the sump gasket (111) or sump compression ring (110). In one embodiment, the outer bolt pattern (107) will consist of 24 ⅜″ bolts.

FIGS. 2a, 2b and 2c provide a perspective, top and side view of the disclosed all inclusive manway and sump connector (103), allowing for a better understanding of the orientation and structure of the inclusive manway and sump connector (103). FIG. 2a depicts a perspective view of the all-inclusive manway and sump connector (103). From this view, the interaction of the inner bolt pattern (106) with the manway cover (108) and manway gasket (109) and the interaction of the outer bolt pattern (107) with the sump gasket (111) and sump compression ring (110) can be more readily appreciated.

As seen in FIG. 2a, the two circles of bolt patterns, the inner bolt pattern (106) and the outer bolt pattern (107) on the lip of the flange (105) allow for the attachment of both the manway cover (108) and the sump without the complex parts, retrofitting, cost and labor associated with the prior art mechanisms and processes. Further, as depicted in FIG. 2a, in one embodiment, the sump compression ring (110), sump gasket (111), manway cover (108) and manway cover gasket (109) can be placed on and adhered to the all-inclusive manway and sump connector (103) simultaneously.

FIG. 2b provides a view of the top of the disclosed all inclusive manway and sump connector (103). From this view, the orientation of inner pattern of bolts (106) and the outer pattern of bolts (107) on the flange (105) as they relate to the inner diameter ring of the flange (105) and the outer diameter ring of the flange (105) are shown. Notably, the dimensions of the various diameters and bolt patterns shown in FIG. 2b are only exemplary. As noted previously, any known diameters, bolt patterns and positioning of the bolts relative to each other that allow for the all-inclusive manway and sump connector (103) to attach to a manway and serve as a point of attachment for both a sump and a manway cover (108) are contemplated in this disclosure. In one embodiment, the inner diameter of the flange is about 24 inches, or has about a 12 inch radius from the center of a circular manway hole, the flange (105) is 8½ inches in width, creating an outer diameter of the flange that is about 32½ inches, or has about a 13¼ inch radius from the center of the circular manway hole (101).

Further, in another embodiment, the inner pattern of bolts (106) is placed on the flange at a diameter of about 26⅜ inches. In the embodiment depicted in FIG. 2b, the inner pattern of bolts (106) is comprised of about 24½ inch bolts. While the bolts of the inner bolt pattern (106) are generally placed at a point equidistant relative to each other along the circle and are radially symmetrical, this orientation is by no means required. Any orientation of the inner bolt pattern (106) that allows it to correspond with the attachment points on a manway cover (108) and/or manway gasket (109) is contemplated in this application. Further, as noted previously, the outer pattern of bolts (107) is positioned closer to the outer diameter than the inner diameter of the flange (105). Specifically, the outer pattern of bolts (107) is placed at a diameter of about 30⅝ inches. In the depicted embodiment, the outer pattern of bolts (107) is comprised of 24⅜ inch bolts. While the bolts of the outer bolt pattern (106) are generally placed at a point equidistant relative to each other along the circle, this orientation is by no means required. Any orientation of the outer bolt pattern (107) that allows it to correspond with the attachment points on a sump, e.g., the sump gasket (111) or sump compression ring (110), is contemplated in this application.

FIG. 2c provides a side view of the disclosed all inclusive manway and sump connector (103). As seen in the FIGS, in some embodiments it is contemplated that the manway flange (105) will be a certain distance away from the surface or ground level. For example, in the embodiment shown in the FIGS, the manway flange (105) is about 10 inches above the surface. Further, FIG. 2c provides an alternative view for seeing how the inner pattern of bolts (106) and the outer pattern of bolts (107) allow for attachment of both the manway cover (through attachment to the manway cover (108) and/or manway gasket (109)) and the sump (through attachment to the sump gasket (111) and/or sump compression ring (110)) to the manway opening (101), without the need for an adapter or the retrofitting of the manway (101) which was required with the devices and modalities of the prior art. Accordingly, this all inclusive solution reduces the costs, labor and parts associated with the traditional devices and modalities, while at the same time increasing the ease of use.

While the invention has been disclosed in conjunction with a description of certain embodiments, including those that are currently believed to be preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. An all-inclusive manway and sump connector for an underground storage tank with a manway, the connector comprising:
a manway throat with a posterior end and an anterior end and a length there between, the anterior end of the manway throat being attached to the manway;
a manway flange attached to and extending out laterally away from the posterior end of the manway throat, the manway flange having a top surface;
an inner bolt pattern sized and shaped to attach to a manway cover and located on the top surface of the manway flange;
an outer bolt pattern sized and shaped to attach to a sump and located on the top surface of the manway flange;
wherein the inner bolt pattern and the outer bolt pattern allow for simultaneous attachment of both the manway cover and the sump to the underground storage tank.

2. The all-inclusive manway and sump connector of claim 1, wherein the manway throat is cylindrical in shape.

3. The all-inclusive manway and sump connector of claim 1, wherein the sump is attached to the outer bolt pattern by attachment openings on a sump gasket.

4. The all-inclusive manway and sump connector of claim 1, wherein the sump is attached to the outer bolt pattern by attachment openings on a sump compression ring.

5. The all-inclusive manway and sump connector of claim 1, wherein the sump is attached to the outer bolt pattern by attachment openings on the sump compression ring and the sump gasket.

6. The all-inclusive manway and sump connector of claim 1, wherein the manway cover is attached to the inner bolt pattern by attachment openings on the manway cover.

7. The all-inclusive manway and sump connector of claim 1, wherein the manway cover is attached to the inner bolt pattern by attachment openings on a manway cover gasket.

8. The all-inclusive manway and sump connector of claim 1, wherein the sump is attached to the inner bolt pattern by attachment openings on a manway cover and a manway cover gasket.

9. The all-inclusive manway and sump connector of claim 1, wherein the manway flange has an inner diameter of about 24 inches, a length of about 8¼ inches and an outer diameter of about 13¼ inches.

10. The all-inclusive manway and sump connector of claim 1, wherein the inner pattern of bolts is located on the top surface of the manway flange at a diameter of about 26⅜ inches.

11. The all-inclusive manway and sump connector of claim 1, wherein the outer pattern of bolts is located on the top surface of the manway flange at a diameter of about 24⅜ inches.

12. A method of simultaneously attaching a manway cover and a sump to a manway opening to an underground storage tank, the method comprising:
providing an underground storage tank with a manway opening;
providing an all-inclusive manway and sump connector connected to the manway opening, the all-inclusive manway and sump connector comprising:
a manway throat with a posterior end and an anterior end and a length there between, the anterior end of the manway throat being attached to the manway;
a manway flange attached to and extending out laterally away from the posterior end of the manway throat, the manway flange having a top surface;
an inner bolt pattern sized and shaped to attach to a manway cover and located on the top surface of the manway flange;
an outer bolt pattern sized and shaped to attach to a sump and located on the top surface of the manway flange;
attaching the manway cover to the inner bolt pattern on the manway flange; and
attaching the sump to the outer bolt pattern on the manway flange.
